(19) United States
(12) Patent Application Publication
(10) Pub. No.: US 2014/0049196 A1
(43) Pub. Date: Feb. 20, 2014

(54) METHOD AND DEVICE FOR AN ELECTRIC MOTOR DRIVE

(71) Applicant: Daniel Salonen, Karjalohja (FI)

(72) Inventor: Daniel Salonen, Karjalohja (FI)

(73) Assignee: AMOTEC OY, Nummela (FI)

(21) Appl. No.: 13/980,587

(22) PCT Filed: Jan. 20, 2012
(86) PCT No.: PCT/FI2012/050053

§ 371 Date: Aug. 26, 2013

(30) Foreign Application Priority Data
Jan. 21, 2011 (FI) 20115056

(51) Int. Cl. B60L 11/18

(52) U.S. Cl. CPC B60L 11/18
USPC 318/139

(57) ABSTRACT

Method and device for an electric-motor drive, particularly in connection with electric vehicles, in which a system consisting of rechargeable batteries produces operating current for the electric motor/electric motors moving the vehicle. An essential part of the method and device is that one single-cell battery, or several single-cell batteries separated galvanically from each other are used, the voltage of which is raised to an acceptable operating-voltage level.

The present invention relates to a method and device for an electric-motor drive. Particularly, though in no way solely, the matter is of an electric-motor drive, which is applied to vehicular use.

At the present time, the development of electrically driven vehicles is very brisk. The reason for this is, among other things, the knowledge that the use of electrically powered vehicles will solve the problems that relate to the emission gases of vehicles powered by combustion engines.

So-called hybrid vehicles are known, in which there is an electric motor as well as a combustion engine, the parallel use of two types of motor, suitably controlled, bringing savings in fuel consumption and, through that, also reducing the climate loading of the exhaust gases. However, the savings achieved by means of vehicles equipped with solutions of the type described are relative small, and are not in proportion to the complexity of the equipment and the consequent increase in price.

A more interesting use, however, of electrical drives in vehicles is vehicles, in which there is only an electric-motor drive. However, the development of these vehicles has encountered problems, which it has still not been possible to solve satisfactorily.

One problem is battery technology. In the type of battery conventionally used, which is usually a lithium-ion (Li-ion) battery, there are tens, hundreds, or even thousands of cells connected in series or in parallel. There are numerous different lithium-ion battery chemistries, and they all give the batteries slightly different properties in terms of energy density, power density, and safety However, they all have in common the fact that they are greatly superior in electricity storage capability compared to old-fashioned lead-acid batteries, and using batteries of the same weight a travel range as much as three times greater can be achieved.

For its part, the weight of the batteries is a serious drawback of batteries storing large amounts of energy.

A lithium-ion battery has, however, some weakness, which affect its usability and price level.

If a battery is discharged fully, or even below a critical level, it is permanently damaged, if it is discharged fully to become empty at a high load, or discharged often repeatedly, it may be destroyed completely.

If a battery is fed current (charged) at an excess voltage, it will begin to heat strongly and may, in extreme cases, go on fire. A battery will also heat strongly when an excessive charging current is used, in which case there will be the danger of a cell with excessive voltage, which, however, is still not full.

If an attempt is made to take more current from a battery than it is able to supply, it will begin to heat up. Once it has heated to more than 70-80° C., the battery will begin to be damaged, and, if the heat continues to increase, it will be irreparably destroyed.

A battery operates best over a very narrow temperate range (+18° C.-+40° C.). If the temperature drops below this, its ability to accept current will be weakened, while temperatures above it will have a detrimental effect on the battery's life.

Electric-vehicle technology, especially the motors, is generally designed to operate at a voltage of 350 V-600 V, while in smaller vehicles the electrical system is usually 72 V or more. Because the voltage of a single cell is typically 3.2 V, as many battery cells must be connected in parallel as are needed to achieve the required voltage. In electric vehicles the size of a private car, this generally means the series connection of about 100-150 cells, usually with a size of 40-90 Ah. Smaller, so-called pencil-sized batteries, originally intended for laptop computers, are widely used and, for instance, the battery pack of the Tesla Roadster electric sports car consists of 6831 cells, which are connected both in parallel and in series, in order to achieve sufficient amounts of voltage and energy.

It is completely obvious that such a set of accumulator batteries is both technically and mechanically complex, and laborious to assemble. However, the real challenge is to make these cells connected in series behave in the same manner as each other. Due to their manufacturing technology, all the cells are individuals, and behave slightly differently in load situations, as well as differing slightly from each other in capacity. The differences are small, but if there are many batteries, and they are charged several times, the differences increase. Connection in series forces the cells to release the same amount of current in every situation, which leads to fluctuations in the charging level and the temperature. Even if it were possible to manufacture cells with identical properties, fluctuations would still almost inevitably be caused in the charge level, because, among other things, it is difficult be bring all the cells to precisely the same temperature. If there are differences in the temperatures of the cells, this will be reflected, through variations in the internal impedance, in variations in the charge level, when the cells are discharged and charged. Eventually, the weakest cells will begin to be destroyed, thus simultaneously causing additional loading on the remaining cells, the life of which will be reduced correspondingly. In addition, charging should stop once the best cell is full, even though the weakest cell would then be only half charged, because otherwise the full cell would be damaged. Similarly, discharging should stop when the weakest cell approaches its critical limit, even though there might be plenty of energy left in the other cells. After a few hundred charging-discharging cycles, only half of the capacity of the bank of cells would remain, and some of the cells would be in a condition close to requiring replacement.

To overcome this problem, battery-management electronics have been developed, which are generally referred to be the acronym BMS (Battery Management System). This should monitor as accurately as possible the voltage and especially the charge level of each cell, as well as the current of the entire circuit. Power supply cannot actually be limited cell-specifically. The charging power of the whole series is restricted once the first cell begins to be full. The only cell-specific limitation takes place by connecting a small resistance cell-specifically in series with the fullest cell. The effect achieved by such balancing is seldom even one watt.

During discharge, the BMS ensures that discharging is stopped, once the weakest cell has used up all of its energy store. If the cell bank is in an electric vehicle, the vehicle's trip stops there. Of course, before that happens, the system will have used other electronics to warn the driver.

The definition of the charge level sets challenges to the functionality of the BMS. The charge level of lithium-ion batteries cannot be determined by simply measuring their voltage, instead it must be calculated cell-specifically with the aid of complex algorithms, which, along with the other operations, demands a great deal of electronics for each cell, and, of course, further increases the cost of the already expensive cell bank by as much as 45%. In addition, the equalization, or balancing, of the charge levels during charging consumes excess energy, because the current going to the cells that are already full is converted into heat, until the weakest cell has been fully charged. Fortunately, it is generally not necessary to do this in connection with every charge, as it consumes not only electricity, but also much time. Balancing an unbalanced cell bank can even take months. In the case of poor-quality cells, the time taken after even one cycle can be as much as a week.

So-called actively balancing systems are also being developed, which transfer energy from one cell to another as required, even during discharge, thus allowing the energy content of the whole cell bank to be used more efficiently, nor is energy wasted as much during charging, because the excess energy is transferred to other cells, instead of being released as heat. However, such a system is even more expensive and complex than the passive system described above. Such a system is indeed being developed, but is not yet in use. According to one version of the B.O.M being developed, a 100-cell battery management system will require as many as 148 000 electronic components.

The service life of a battery is very important to customers, as it affects not only their own use of a car, but also its resale value, as it will be extremely expensive to change a worn-out battery bank even years ahead. The service life and operating reliability of a normal battery bank are affected most of all by precisely the management system, the limited precision and reliability of which makes it very challenging at present to give a warranty for the battery bank of an electric or hybrid vehicle, so, to be on the safe side, it is calculated considerably under the theoretical cycle durability and service life.

The battery banks of present factory-made electric cars must be considerably over-dimensioned, because the duration of charging and the service life also affect what percentage of the batteries' capacity can be used for each discharge. In the case of a battery bank consisting of hundreds of cells, it is completely impossible to decide whether some cell will use more of its capacity than some other cell, so that to be sure the limits are kept certainly safe. The end user then pays for a great deal of dead weight in their vehicle, and the manufacturer's production costs rise even further. For example, in the Chevy Volt plug-in hybrid, sales of which started in the USA at the end of 2010, a maximum of 50% of the battery capacity is used. As a result, the real energy density drops to less than half of the nominal density of the lithium battery, putting it in the same class as a lead-acid battery.

On the basis of the detailed description above, it is easy to conclude that, in the case of electrically-powered vehicles, there are numerous problems, quite many of which relate precisely to battery technology.

Thus, the present invention is intended to create a method and device, with the aid of which many of the problems plaguing the prior art can be solved.

The advantages and benefits of the invention are achieved in a manner, the characteristic features of which are stated in the accompanying Claims.

In the following, the invention is described in greater detail with reference to the accompanying schematic diagrams, which show:

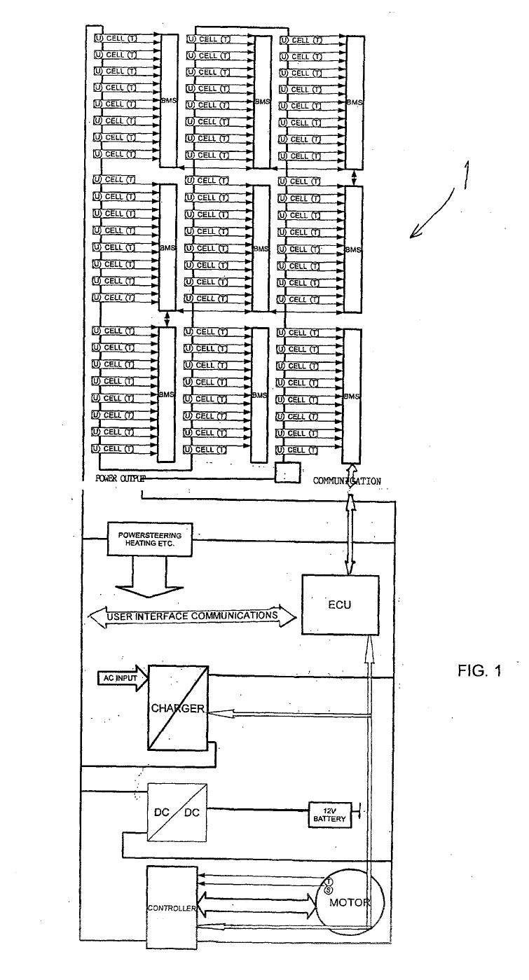

in FIG. 1, an example of a system according to the prior art; and

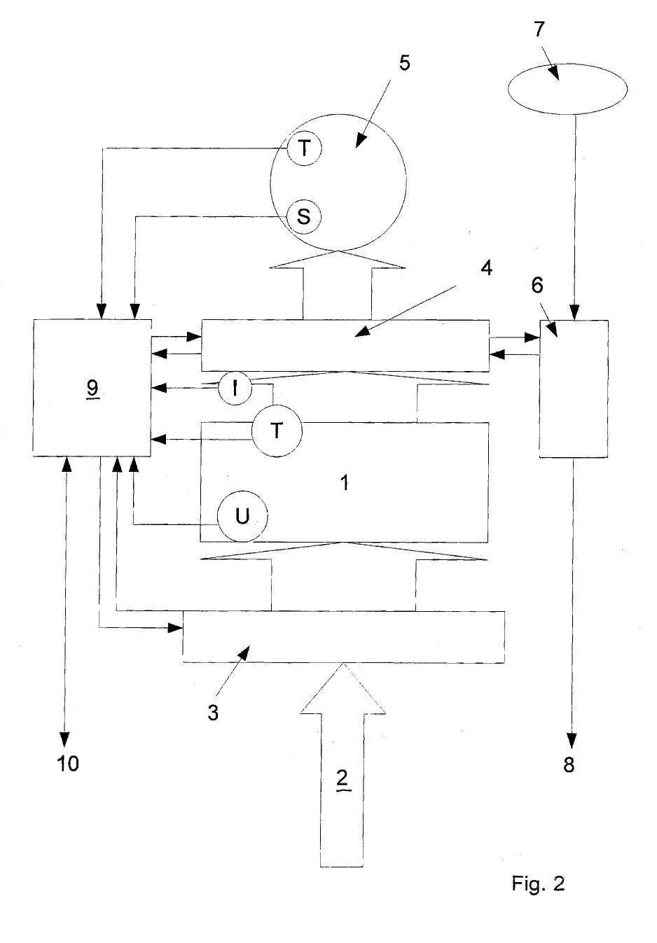

in FIG. 2, one example of a system diagram according to the invention.

Thus, FIG. 1 shows one example of a system of a battery arrangement of an electric car presently in use. In this case, the batter 1 comprises 72 separate cells, which are controlled in eight-cell series by an electronic BMS device, which seeks to manage the properties referred to above in the description of the prior art. Assuming that the cell voltage is 3.2 V, the output voltage of the battery will be about 230 V.

As such, the said system includes conventional transformers, control units, and a separate charging unit and similar system components.

As stated, the problems relate precisely to the battery pack, in which there are structurally difficult points, due to the very many cells. The control of the cells also causes very great problems, due to which the batteries are always in danger of being damaged, while the possibility of using their full capacity is also excluded for reasons of reliability. In addition, such a structure is highly complex and liable to be very unreliable, due to its electrical and mechanical construction.

Contrary to what is generally believed, it has now been invented that it is, surprisingly, possible to use a battery containing only a single cell as a power source for an electrically-powered vehicle. In brief, this realization solves practically all the problems that have up until now been associated with multi-cell systems. Of course, drawing such great power from a low voltage brings with it challenges, but they can be resolved. The challenges relate mainly to scale and optimization, and not to numerous vague variables.

FIG. 2 shows a rough basic diagram of a system according to the invention. In FIG. 2, the single-cell battery is marked with the reference number 1. The battery is charged with the aid of a charging device 3, to which convention alternating current is fed, for example, from a wall socket. The charging device 3 converts the alternating current to direct current for charging.

Direct current is fed to the motor 5 from the battery 1 through a converter 4. The converter 4 raises the voltage to the desired level and then feeds it to the motor, either as direct current or as alternating current, according to the type of motor it is intended to use.

Because the matter concerns a vehicle, particularly a car, its numerous functions are controlled using various electronic regulators or control units. One such is marked with the reference number 6. By way of example, the operation of the accelerator 7 is connected to the control unit 6. On the other hand, the reference number 8 is used to mark an output from the regulator 6, through which output many other functions are controlled, such as functions relating to the safety of the vehicle and similar.

In FIG. 2, various measurement points and sensors are marked with letter symbols. For example, current is measured as shown by the reference I, the measurement of voltage is correspondingly shown by the reference letter U and the temperature sensors are marked with the reference letter T. The letter S in connection with the motor 5 represents the speed sensor. It is obvious that there can be many other measurement points and sensors, but at least the most important and certainly the essential measurements are itemized here.

The system is intended to be built primarily for an AC motor. However, in special applications it can be converted for DC operation. In this case, as in other motor drives, the power of the motor, i.e. its torque, is regulated by regulating the voltage, i.e. the current. Speed is regulated by controlling the frequency. It is characteristic of this device that the voltage is increased only when required. In vehicular use, full power is required less than 10% of the time, at other times an average of about 50% of power is sufficient. Thus, if the voltage is increased from 3.2 Volts to 100 Volts to obtain full power, it need be increased to only 75 Volts to obtain 50% of the power. This increases efficiency at lower power levels. In conventional AC-motor drives, voltage is fed to the motor from DC voltage.

On the other hand, the system also comprises at least one other control unit, which is marked in the figure by the reference number 9. This unit is related specifically to the battery and the control and regulation of the electrical system, as the arrows clearly show. The control unit 9 receives measurement data from both the charging device 3 and the voltage converter 4 and motor 5. Data giving the charge state of the battery 1 is very important. Because there is only one cell in the battery, information on its state is very explicit and control of the battery state is thus precise and easy.

All the energy in both directions can be calculated. As there is only one cell, it is possible to be certain that all the energy has gone to this one cell. Thus, the charge level can be determined precisely.

As in the case of the control unit 6, information is also obtained from the control unit 9 as output 10 for the most diverse purposes.

By using a single large cell instead of ten or a hundred small cells, a considerable proportion of the problems presently limiting the use of the technology can be avoided. When using a single cell, it releases current precisely according to its own capacity and other properties and need not be compelled to release the same amount at precisely the same moment as more than a hundred other cells. This lengthens the battery's life, increases the number of cycles available, and permits the more efficient utilization of the entire capacity of the battery.

In addition to the large battery, a DC/DC or DC/AC converter is required, which increases the battery's 3.2-V voltage to a level of 90-120 V. The voltage is increased only as required, and not all the time to a specific level. There is no need to raise the voltage higher than this if smaller motors are used, for example, one to each wheel. The lower voltage also permits the use of MOSFET transistors in the motor controller, instead of less efficient and more expensive IGBT transistors, which in addition make an unpleasant high-frequency noise in use. The system also permits the use of a DC/DC converter in charging and even in fast charging, using the existing grid, nor does it require a separate charger.

The device cannot be used directly as a charger, but it can be used to regulate the charging power. However, the device requires a rectifier to the charging side. The existing grid refers to an EU standard, according to which service stations should reserve a 3˜400-VAC, 64-A outlet for chargers. This connection can be used to directly charge a car, without external additional devices.

The system to which the invention relates has been envisaged as being modular. The continuous output of the one system in the schematic diagram is about 20 kW, and would permit the use of a momentary output of about 40 kW (for at most about one minute at a time). Such would be sufficient for electric fork-lift trucks and L7e-class quad bikes. By using two systems, a sporty performance would be obtained for small cars and using four would move an SUV, or even a sports car. The same components can be used for each variation, which brings cost advantages in the form of mass production. The systems communicate with each other electrically by signals, so that they can be installed on the same or different axles without the power losses of mechanical differentials and transmissions.

When using two or four systems in a vehicle, there would be more than one cell, but the essential aspect is that they have no galvanic connection with each other, so that they behave like a single cell. The small differences in the power output capability of the cells can be compensated by equalizing the loads as required using commands of the electronic control unit. In addition, it is easier to select four cells at the factory for one vehicle to balance their properties than it is to select more than one hundred or one thousand. The small variation in power between the driving wheels will not affect road-holding. In traditional combustion-engine cars, the differential varies the torque from one driving wheel to another continuously while running.

Temperature control and casing and attachment for vehicular use are considerably easier to implement for one cell than for hundreds of smaller units. Using certain techniques it is even possible to implement a heating/cooling system inside the cell itself, in which case temperature control will be more effective.

According to the invention, the amount of energy of the battery/battery bank is increased by raising the capacity, instead of series connection. Thus, the relative share of the casing and terminal structures of the weight of the cell diminishes as the cell's size is increased. According to one calculation, an increase in the cell size from 40 Ah to 7000 Ah signifies an increase of 65% in the energy density relative to the weight.

It is easier to predict the behaviour of the battery, making it possible to give a warranty for running time and charging cycles that is closer to the real performance, which will also be better, thanks to the system described. Because it is easier to monitor the battery's charge state, a considerably larger part of its capacity can be used, and the user will not have to carry with them excess ballast, which for its part will also help to reduce energy consumption.

Up until now, electrical technology exclusively for vehicles has been developed to a very minor extent and most of both the technology and its designers have an industrial background and reflect its operating environment and standards. In industrial operation, there would be no sense in transferring as great an amount of current as that required by the system according to the invention and thus raising the low voltage to such an extent, because the cabling and other practices in an industrial environment would give an efficiency that would be uneconomical. In vehicular use, the actual cabling prior to raising the voltage can be minimized, or even entirely eliminated by placing the voltage converter right on the battery, or even building it into the battery, because the battery will probably in any event be designed separately precisely for this use.

As will be obvious from the above, the brings the field numerous new and innovative aspects, with the aid of which the usability, control, and costs of electric-motor-powered vehicles can be brought to a level that is clearly more acceptable than that of solutions known up until now.

It should be noted that the invention can be adapted in many ways. The numerical values presented above in relation to voltage, current, or power are only given as exemplary, though probable values in practical applications.

1. Method for an electric-motor drive particularly in connection with electric vehicles, in which a system consisting of chargeable batteries produces drive current for an electric motor/electric motors moving the vehicle, characterized in that one single-cell battery is used, or several single-cell batteries separated galvanically from each other are used, the voltage of which is raised to an acceptable operating-voltage level.

2. Method according to claim 1, characterized in that the vehicle is equipped with two single-cell electrical systems separated galvanically from each other.

3. Method according to claim 1, characterized in that the vehicle is equipped with four single-cell electrical system separated galvanically from each other.

4. Method according to claim 1, characterized in that the battery's voltage of about 3.2 V is raised by a DC/DC or DC/AC converter to a level of 90-120 V for the motor drive.

5. Method according to any of the above claims, characterized in that the converter (4) for raising the voltage is placed in the immediate vicinity of the battery (1), or even integrated in the battery.

6. Method according to claim 1, characterized in that at least two cell separated galvanically from each other and used for each motor.

7. Method according to claim 1, characterized in that each cell drives more than one motor.

8. Method according to claim 1, characterized in that the voltage is raised as required to only an operating level lower than the desired level.

9. Method according to claim 1, characterized in that the motor's power is regulated by raising the voltage fed to the motor, directly without intermediate voltage circuits.

10. Method according to claim 8, characterized in that the motor's speed is regulated by adjusting the frequency of the voltage being fed.

11. Device for an electric-motor drive, particularly in connection with electric vehicles, in which a system consisting of rechargeable batteries produces an operating current for the electric motor/electric motors moving the vehicle, characterized in that in the device there is one single-cell battery, or several single-cell batteries separated galvanically from each other.

12. Device according to claim 11, characterized in that it comprises a DC/DC or DC/AC converter for raising the battery's voltage to the desired operating-voltage level.

13. Device according to claim 11, characterized in that it comprises two or four single-cell electrical systems separate galvanically from each other.

14. Device according to claim 11, characterized in that the converter (4) for raising the voltage is placed in the immediate vicinity of the batter (1) or is integrated in it.

15. Device according to claim 11, characterized in that the converter (4) for raising the voltage is connected directly to the motor/motors.
